(19) United States
(12) Patent Application Publication
(10) Pub. No.: US 2026/0103838 A1
(43) Pub. Date: Apr. 16, 2026

(54) Treatment Liquid Composition For Dye Textile Printing, Composition Set, And Textile Printing Method

(71) Applicant: SEIKO EPSON CORPORATION, Tokyo (JP)

(72) Inventors: Toshiaki OGUCHI, Okaya (JP); Kazuki SHIMURA, Yamagata (JP); Yuta ASAKAWA, Azumino (JP)

(21) Appl. No.: 19/353,969

(22) Filed: Oct. 9, 2025

(30) Foreign Application Priority Data
Oct. 10, 2024 (JP) 2024-178307

(51) Int. Cl. D06P 1/613; C09D 11/102; C09D 11/40; C09D 11/54; D06P 1/52; D06P 1/54; D06P 3/60; D06P 5/00; D06P 5/30

(52) U.S. Cl. CPC D06P 1/613; C09D 11/102; C09D 11/40; C09D 11/54; D06P 1/5285; D06P 1/54; D06P 5/002; D06P 5/30; D06P 3/6033

(57) ABSTRACT

A treatment liquid composition for dye textile printing contains a resin, a crosslinking agent, an additive, and water, in which the additive includes a compound having a polyoxyalkylene structure, and the compound having a polyoxyalkylene structure is one or more selected from a polyoxyalkylene-glyceryl ether, a polyoxyalkylene-polyglyceryl ether, and a polyoxyalkylene block polymer.

The present application is based on, and claims priority from JP Application Serial Number 2024-178307, filed Oct. 10, 2024, the disclosure of which is hereby incorporated by reference herein in its entirety.

### BACKGROUND

### 1. Technical Field

The present disclosure relates to a treatment liquid composition for dye textile printing, a composition set, and a textile printing method.

### 2. Related Art

A technique is known in which a pretreatment is performed on a fabric using a pretreatment liquid for the purpose of using a sublimation transfer ink used for dyeing a polyester fabric for dyeing a fabric other than the polyester fabric. As such a technique, for example, a base liquid containing sodium carboxymethyl cellulose (CMC) or polyvinyl alcohol (PVA), for using a sublimation type disperse ink for polyester fibers in printing, on a cotton fabric is disclosed (for example, see JP-A-2003-201687).

However, CMC and PVA contained in the base liquid disclosed in JP-A-2003-201687 have low affinity with the sublimation dye, and thus color developing property of the dye is not improved. In addition, by using the pretreatment liquid, components such as a surfactant, remaining in the fabric, migrate together with the pretreatment liquid, and pretreatment marks are generated by localization of the components.

### SUMMARY

According to an aspect of the present disclosure, a treatment liquid composition for dye textile printing contains a resin, a crosslinking agent, an additive, and water, in which the additive includes a compound having a polyoxyalkylene structure, and the compound having a polyoxyalkylene structure is one or more selected from a polyoxyalkylene-glyceryl ether, a polyoxyalkylene-polyglyceryl ether, and a polyoxyalkylene block polymer.

### BRIEF DESCRIPTION OF THE DRAWINGS

FIG. 1 is Table 1 showing formulations of treatment liquid compositions 1 to 9.

FIG. 2 is Table 2 showing formulations of treatment liquid compositions 10 to 18.

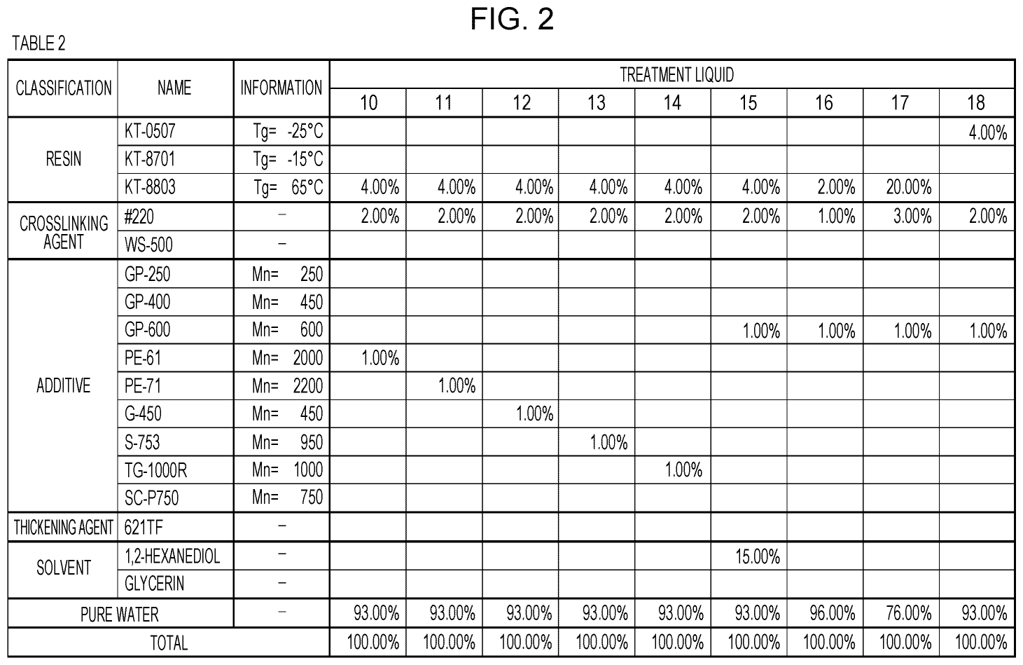

FIG. 3 is Table 3 showing formulations of treatment liquid compositions 19 to 27.

FIG. 4 is Table 4 showing a formulation of an ink jet ink composition.

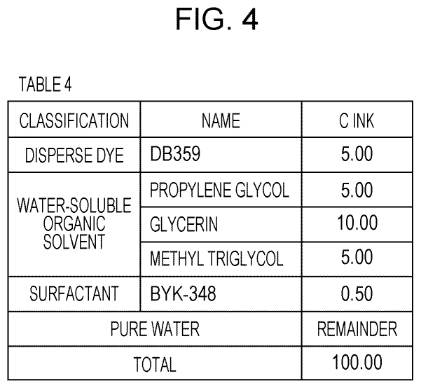

FIG. 5 is Table 5 showing evaluation results of Examples 1 to 9.

FIG. 6 is Table 6 showing evaluation results of Examples 10 to 18.

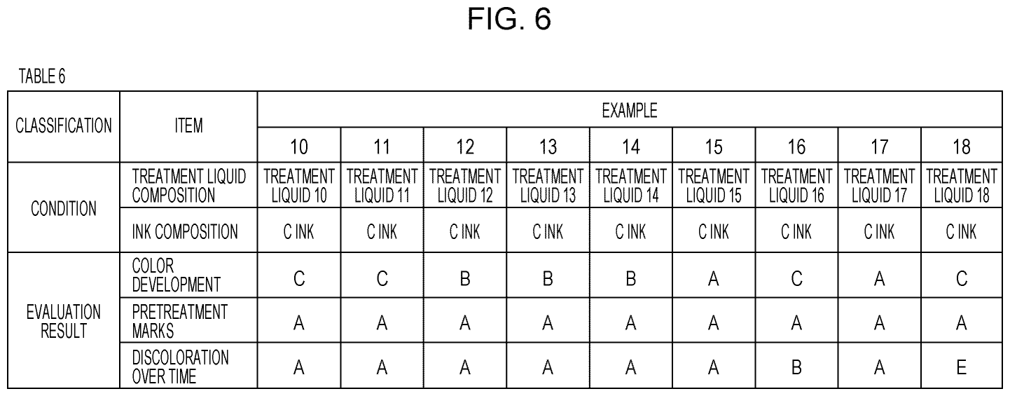

FIG. 7 is Table 7 showing evaluation results of Examples 19 to 24 and Comparative Examples 1 to 3.

### DESCRIPTION OF EMBODIMENTS

Hereinafter, embodiments of the present disclosure will be described. The embodiments described below describe examples of the present disclosure. The present disclosure is not limited to the following embodiments, and includes various modifications implemented within a range not changing a gist of the present disclosure. It should be noted that not all of the configurations described below are essential configurations of the present disclosure.

In the present specification, “textile printing” refers to recording or printing of ink on a recording medium including a fabric, and is also referred to as “printing”. In addition, the recording medium after the textile printing is referred to as “textile printed matter” or “printed matter”.

In the present specification, “ink jet textile printing” refers to recording (printing) an ink composition on a recording medium including a fabric by an ink jet method.

### 1. TREATMENT LIQUID COMPOSITION FOR DYE TEXTILE PRINTING

A treatment liquid composition for dye textile printing (hereinafter, also referred to as “treatment liquid composition”) according to one embodiment of the present disclosure contains a resin, a crosslinking agent, an additive, and water, in which the additive includes a compound having a polyoxyalkylene structure, and the compound having a polyoxyalkylene structure is one or more selected from a polyoxyalkylene-glyceryl ether, a polyoxyalkylene-polyglyceryl ether, and a polyoxyalkylene block polymer.

In a fabric used for dye textile printing, when a treatment liquid composition is attached to the fabric in advance and the dye textile printing is performed, pretreatment marks may be generated on the fabric. Specifically, yellowing occurs at an edge portion of a range to which the treatment liquid composition is attached.

It is presumed that the cause of the pretreatment marks is potassium ions, sodium ions, or the like, which are contained in a surfactant, a sizing agent, an optical brightening agent, or the like used for the fabric. The fabric used for dye textile printing is manufactured through a process of using components such as the surfactant, the sizing agent, and the optical brightening agent, so that these components are substantially uniformly remaining over the entire fabric. When the treatment liquid composition is attached to the fabric and then dried, the treatment liquid composition migrates in the fabric as the drying proceeds. The potassium ions or the sodium ions on a surface of the fabric also migrate in accordance with the migration of the treatment liquid composition. In particular, when moisture evaporates by applying pressure with heat press in the drying step, steam escapes from an unpressed portion, and thus the above-described ions migrate to the vicinity of the unpressed portion and are localized. Furthermore, when the fabric is heated, the above-described ions react with carbon dioxide in the air to form a carbonate. It is presumed that the localized carbonate appears at the edge of the range to which the pretreatment liquid is attached as the pretreatment marks.

The reason why the excellent effect is obtained in the present embodiment is not clear, but the present inventors presume as follows.

By containing one or more selected from a polyoxyalkylene-glyceryl ether, a polyoxyalkylene-polyglyceryl ether, and a polyoxyalkylene block polymer as the additive in the treatment liquid composition, a viscosity of the treatment liquid composition in the fabric is improved, and thus a moving speed is reduced. Therefore, the accompanying migration and localization of the potassium ions or the sodium ions can be reduced. In addition, the compound having a polyoxyalkylene structure, contained in the additive, exhibits nonionicity when dissolved in water, and thus no counterions are generated in the treatment liquid composition. That is, since sodium ions and the like, which are the cause of the pretreatment marks, are not generated, it is presumed that carbonates caused by the treatment liquid composition are unlikely to be generated.

In addition, it is presumed that the compound having an oxyalkylene structure permeates the fabric in a state in which the dye is dissolved or dispersed, so that the fabric is dyed to the inside, and the printed matter exhibits favorable color development. However, the reason is not limited to this.

Hereinafter, components that can be contained in the treatment liquid composition for dye textile printing according to the present embodiment will be described in detail.

### 1.1. Resin

The treatment liquid composition for dye textile printing according to the present embodiment contains a resin.

A content of the resin is preferably 2% by mass or more, more preferably 3% by mass or more, and still more preferably 4% by mass or more in terms of solid content with respect to the total amount of the treatment liquid composition. In addition, the content of the resin is preferably 20% by mass or less, more preferably 15% by mass or less, and still more preferably 10% by mass or less in terms of solid content. When the content of the resin is within the above-described range, the printed matter exhibits favorable color development.

A glass transition temperature (Tg) of the resin is preferably 25° C. or higher, more preferably 35° C. or higher, and still more preferably 50° C. or higher. When the glass transition temperature of the resin is within the above-described range, discoloration of the printed matter over time (hereinafter, also referred to as “discoloration over time”) is reduced.

In addition, the glass transition temperature of the resin is preferably 180° C. or lower, more preferably 150° C. or lower, and still more preferably 100° C. or lower.

The glass transition temperature can be measured by a differential scanning calorimetry (DSC) or the like.

Examples of the resin include a polyester resin, a urethane resin, an addition polymerization resin, a fluororesin, and a natural resin. A form of the resin is not particularly limited, but it is preferable that the resin is resin particles. The resin particles are often handled in an emulsion form, that is, as a resin dispersion, but may be supplied in a powder form. Regarding the resin particles, one kind thereof may be used alone, or two or more kinds thereof may be used in combination.

As the resin, it is particularly preferable to contain a polyester resin. When the treatment liquid composition contains a polyester resin, the printed matter exhibits favorable color development and the discoloration over time is also reduced.

Examples of the polyester resin include a resin having a constituent unit derived from a polycarboxylic acid and a constituent unit derived from a polyhydric alcohol.

Examples of the polycarboxylic acid contained in the polyester resin include terephthalic acid, isophthalic acid, orthophthalic acid, phthalic acid, 4,4′-diphenyldicarboxylic acid, 2,5-naphthalenedicarboxylic acid, 1,5-naphthalenedicarboxylic acid, and 2,6-naphthalenedicarboxylic acid, 2,7-naphthalenedicarboxylic acid, 1,4-cyclohexanedicarboxylic acid, 2-potassium sulfoterephthalic acid, 5-sodium sulfoisophthalic acid, adipic acid, azelaic acid, sebacic acid, dodecanedicarboxylic acid, glutaric acid, succinic acid, trimellitic acid, trimesic acid, pyromellitic acid, trimellitic anhydride, phthalic anhydride, succinic anhydride, p-hydroxybenzoic acid, and salts thereof. Examples of the salt include a potassium salt, a sodium salt, a calcium salt, and a magnesium salt.

Examples of the polyhydric alcohol contained in the polyester resin include ethylene glycol, 1,2-propylene glycol, 1,3-propylene glycol, 1,3-propanediol, 1,3-butylene glycol, 1,4-butanediol, 1,6-hexanediol, 2-methyl-1,5-pentanediol, neopentyl glycol, 1,4-cyclohexanedimethanol, p-xylylene glycol, bisphenol A-ethylene glycol adduct, diethylene glycol, triethylene glycol, polyethylene glycol, polypropylene glycol, polytetramethylene glycol, polytetramethylene oxide glycol, dimethylolpropionic acid, glycerin, trimethylolpropane, sodium dimethylolethylsulfonate, potassium dimethylolethylsulfonate, and potassium dimethylolpropionate.

It is preferable that the polyester resin has a hydroxy group, a carboxy group, a sulfonic acid group, or sodium salts thereof. The above-described group may be contained in the polyester resin in one or two or more kinds.

In addition, the polyester resin is also preferably a sulfonic acid group-containing polyester resin having the above-described constituent unit derived from a polycarboxylic acid, the above-described constituent unit derived from a polyhydric alcohol, and a constituent unit derived from a sulfonic acid group-containing aromatic monomer.

Examples of the sulfonic acid group-containing aromatic monomer include 5-sulfoisophthalic acid, sulfoterephthalic acid, 4-sulfophthalic acid, 4-sulfonaphthalene-2,7-dicarboxylic acid, 4-sulfo-1,8-naphthalenedicarboxylic acid anhydride, and salts thereof. As the salt, for example, a sodium salt is preferable.

When the polyester resin has a hydroxy group, a carboxyl group, or a sulfonic acid group, a reaction with the crosslinking agent is improved, and binding property with the fabric, preferably the fabric containing a fiber having a hydroxy group, is improved. Therefore, it is possible to obtain a printed matter exhibiting a more favorable color development and texture, and having less discoloration over time.

The polyester resin may be obtained by selecting one or more kinds of, for example, the polycarboxylic acid, the polyhydric alcohol, and the sulfonic acid group-containing aromatic monomer as necessary, from each of the above, and synthesizing by a known polycondensation reaction. In addition, a commercially available product may be used.

Examples of the commercially available product of the polyester resin include ELITEL (registered trademark) KT-0507, KT-8701, KT-9204, and KT-8803 (all product names manufactured by Unitika, Ltd.); PLUSCOAT (registered trademark) Z-221, Z-446, Z-561, Z-565, RZ-570, Z-592, Z-687, Z-690, Z-730, Z-760, RZ-105, and RZ-570 (all product names manufactured by Goo Chemical Co., Ltd.); and VYLONAL (registered trademark) MD-1200, MD-1500, and MD-2000 (all product names manufactured by TOYOBO MC Corporation).

Examples of the urethane resin include a polyether-type urethane resin having an ether bond in a main chain, a polyester-type urethane resin having an ester bond in a main chain, and a polycarbonate-type urethane resin having a carbonate bond in a main chain, the resin having a urethane bond. The urethane resin may be synthesized by a known method or may be a commercially available product. Examples of the commercially available product of the urethane resin include Superflex (registered trademark) 460, 460s, 860, and E-2000 (all product names manufactured by DKS Co., Ltd.); Resamine (registered trademark) D-1060, D-2020, D-4080, D-4200, D-6300, and D-6455 (all product names manufactured by Dainichiseika Color & Chemicals MFG Co., Ltd.); Takelac (registered trademark) W-6061, WS-6021, and W-512-A-6 (all product names manufactured by Mitsui Chemicals, Inc.); Sancure (registered trademark) 2710 (product name manufactured by Lubrizol Corporation); and Permarin (registered trademark) UA-150 (product name manufactured by Sanyo Chemical Industries, Ltd.).

Examples of the addition polymerization resin include homopolymers or copolymers of acrylic acid, methacrylic acid, acrylic acid ester, methacrylic acid ester, acrylonitrile, cyanoacrylate, acrylamide, olefin, styrene, silicone, rosin, terpene, epoxy, vinyl acetate, vinyl chloride, vinyl alcohol, vinyl ether, vinylpyrrolidone, vinylpyridine, vinylcarbazole, vinylimidazole, and vinylidene chloride.

Regarding the resin, one kind thereof may be used alone, or two or more kinds thereof may be used in combination.

### 1.2. Crosslinking Agent

The treatment liquid composition for dye textile printing according to the present embodiment contains a crosslinking agent.

Since the treatment liquid composition contains a crosslinking agent, crosslinkability is imparted, and it is possible to bind the resin, the dye, and the fabric. Therefore, the printed matter exhibits favorable color development.

The crosslinking agent is preferably one or more selected from an isocyanate compound and an oxazoline compound, and more preferably an isocyanate compound. By using an isocyanate compound as the crosslinking agent, a hydroxy group contained in the additive described later can be favorably crosslinked, so that the color development of the printed matter is also favorable and the discoloration over time can be reduced.

Examples of the isocyanate compound include a water dispersion-type polyisocyanate and a water dispersion-type blocked polyisocyanate. Regarding the isocyanate compound, one kind thereof may be used alone, or two or more kinds thereof may be used in combination.

Examples of the water dispersion-type polyisocyanate include products obtained by dispersing a polyisocyanate that is imparted with hydrophilicity by a polyethylene oxide chain, in water with an anionic dispersant or a nonionic dispersant.

Examples of the polyisocyanate include diisocyanates such as hexamethylene diisocyanate and isophorone diisocyanate; and derivatives (modification products) of polyisocyanate, such as a trimethylolpropane adduct form, a biuret form, and an isocyanurate form of these diisocyanates. Regarding the polyisocyanate, one kind thereof may be used alone, or two or more kinds thereof may be used in combination.

The water dispersion-type blocked polyisocyanate is obtained by adding a blocking agent to an isocyanate group of the water dispersion-type polyisocyanate to inactivate the isocyanate group at normal temperature. Examples of the blocking agent include an active methylene compound, an oxime compound, a lactam compound, an alcohol compound, a phenol compound, an amine compound, a pyrazole compound, a mercaptan compound, and an imidazole compound. Specific examples thereof include diethyl malonate, ethyl acetoacetate, butanone oxime, cyclohexanone oxime, ε-caprolactam, methanol, ethanol, phenol, cresol, 1,2,4-triazole, pyrazole, 3,5-dimethylpyrazole, and imidazole. Regarding the blocking agent, one kind thereof may be used alone, or two or more kinds thereof may be used in combination.

The crosslinking agent is preferably an isocyanate compound having an isocyanurate skeleton. Since the isocyanate compound having an isocyanurate skeleton has at least three crosslinking points, the binding property between the resin and the fabric can be more suitable. Therefore, it is possible to obtain a printed matter exhibiting excellent color development.

Examples of a commercially available product of the isocyanate compound include FIXER #220, #70, #70ECO, #400, #410, #100ECO, #104EA, and #200ECO (all product names manufactured by Murayama Chemical Laboratory Co., Ltd.); and ELASTRON (registered trademark) BN-11, BN-27, BN-77, and BN-69 (all product names manufactured by Daiichi Kogyo Seiyaku Co., Ltd.).

As the oxazoline compound, a compound having two or more oxazoline groups in the molecule is preferable. Examples of the oxazoline compound having two or more oxazoline groups in the molecule include 2,2′-bis(2-oxazoline), 2,2′-methylene-bis(2-oxazoline), 2,2′-ethylene-bis(2-oxazoline), 2,2′-trimethylene-bis(2-oxazoline), 2,2′-tetramethylene-bis(2-oxazoline), 2,2′-hexamethylene-bis(2-oxazoline), 2,2′-octamethylene-bis(2-oxazoline), 2,2′-ethylene-bis(4,4′-dimethyl-2-oxazoline), 2,2′-p-phenylene-bis(2-oxazoline), 2,2′-m-phenylene-bis(2-oxazoline), 2,2′-m-phenylene-bis(4,4′-dimethyl-2-oxazoline), bis(2-oxazolinylcyclohexane) sulfide, bis(2-oxazolinylnorbornane) sulfide and an oxazoline ring-containing polymer. Regarding the oxazoline compound, one kind thereof may be used alone, or two or more kinds thereof may be used in combination.

The oxazoline compound may be synthesized by a known method or may be a commercially available product.

Examples of the commercially available product of the oxazoline compound include EPOCROS (registered trademark) WS-300, WS-500, WS-700, K-2010E, K-2020E, and K-2035E (all manufactured by Nippon Shokubai Co., Ltd.).

Regarding the crosslinking agent, one kind thereof may be used alone, or two or more kinds thereof may be used in combination.

A content of the crosslinking agent is preferably 0.5% by mass or more and 5% by mass or less, more preferably 1% by mass or more and 3% by mass or less, and still more preferably 1% by mass or more and 2.5% by mass or less in terms of solid content with respect to the total amount of the treatment liquid composition. When the content of the crosslinking agent is within the above-described range, it is possible to obtain a printed matter exhibiting favorable color development.

### 1.3. Additive

The treatment liquid composition for dye textile printing according to the present embodiment contains an additive. The additive includes a compound having a polyoxyalkylene structure, and the compound having a polyoxyalkylene structure is one or more selected from a polyoxyalkylene-glyceryl ether, a polyoxyalkylene-polyglyceryl ether, and a polyoxyalkylene block polymer.

Since the treatment liquid composition contains the additive, the viscosity of the treatment liquid composition is improved, and thus the moving speed of the treatment liquid composition in the fabric during the drying step is reduced. Therefore, migration and localization of sodium ions and the like on the fabric due to the migration of the treatment liquid composition are reduced, and thus the occurrence of the pretreatment marks is reduced.

Furthermore, the compound having a polyoxyalkylene structure, contained in the additive, exhibits nonionicity when dissolved in water, and thus no counterions are generated in the treatment liquid composition. That is, since the sodium ions and the like, which are the cause of the pretreatment marks, are not generated, the pretreatment marks caused by the treatment liquid composition containing the additive does not occur.

In addition, the additive can dye the fabric to the inside by permeating the fabric in a state in which the dye is dissolved or dispersed. Since the state in which the dye is dissolved or dispersed can be maintained, when an image formed of the dye is heat-transferred to the fabric after applying the treatment liquid composition to the fabric and drying the fabric, the diffused dye can be temporarily held in the residual additive. As a result, it is possible to obtain a printed matter that can dye the resin well and exhibits favorable color development.

The polyoxyalkylene-glyceryl ether, the polyoxyalkylene-polyglyceryl ether, and the polyoxyalkylene block polymer, which are the compound having a polyoxyalkylene structure, have a hydroxy group in the molecule. The hydroxy group of the additive is bonded by the crosslinking agent, and the flexible polyoxyalkylene structure is introduced between the bonding of the crosslinking agent, so that the bonding is extended and thus deterioration of the texture due to the crosslinking can be reduced.

The number of hydroxy groups of the above-described compound having a polyoxyalkylene structure is preferably 2 or more, and more preferably 3 or more. When the compound having a polyoxyalkylene structure has the above-described number or more of hydroxy groups, the bonding by the crosslinking agent is extended, and thus the deterioration of the texture due to the crosslinking can be reduced. In addition, the hydroxy groups are bonded to each other by the crosslinking agent to form a part of a three-dimensional crosslinked structure, so that the resin, the dye, and the fabric can be more bonded to each other, and thus the color development is improved.

The number of carbon atoms in an oxyalkylene group constituting the polyoxyalkylene structure is preferably 2 or more, and more preferably 3 or more. In addition, the number of carbon atoms in the oxyalkylene group is preferably 4 or less. Examples of such a polyoxyalkylene structure include a polyoxyethylene structure, a polyoxypropylene structure, and a polybutylene structure.

The compound having a polyoxyalkylene structure may have oxyalkylene groups having different numbers of carbon atoms in the molecule. Examples of the structure having oxyalkylene groups having different numbers of carbon atoms include a mixed structure of a polyoxyethylene structure and a polyoxypropylene structure, and a mixed structure of a polyoxybutylene structure, a polyoxyethylene structure, and a polyoxypropylene structure.

The compound having a polyoxyalkylene structure has a structure in which oxyalkylene groups having different numbers of carbon atoms are present in the molecule, and a part of the alkylene group in the molecule acts as a hydrophobic group, so that the compound exhibits amphiphilicity. As a result, affinity between the dye having hydrophobicity and the fiber of the fabric having hydrophilicity is improved, and the fabric can be dyed to the inside thereof, so that the color development is improved and the discoloration over time is also reduced.

Examples of a commercially available product of the compound having a polyoxyalkylene structure include, for example, SANNIX (registered trademark) GP-250, GP-400, GP-600, and GP-1000, and NEWPOL (registered trademark) PE-34, PE-61, PE-62, and PE-71 (all product names manufactured by Sanyo Chemical Industries, Ltd.); UNIOX (registered trademark) G-450 and G-750, UNIOL (registered trademark) TG-330 and TG-1000R, and WILBRIDE (registered trademark) S-753 (all product names manufactured by NOF CORPORATION); and SC-P750, SC-P1000, SC-P1600, SC-E350, SC-E750, SC-E1000, SC-E1500 (all product names manufactured by Sakamoto Yakuhin Kogyo Co., Ltd.).

A number-average molecular weight (Mn) of the compound having a polyoxyalkylene structure is preferably 150 or more, more preferably 200 or more, and still more preferably 250 or more. When the molecular weight is within the above-described range, the viscosity of the treatment liquid composition can be improved, and the occurrence of the pretreatment marks can be reduced. In addition, the number-average molecular weight of the compound having a polyoxyalkylene structure is preferably 2,500 or less, more preferably 2,000 or less, and still more preferably 1,000 or less. The number-average molecular weight (Mn) when a plurality of compounds having a polyoxyalkylene structure are present can be a weighted average that is the sum of the product of the number-average molecular weight of each compound having a polyoxyalkylene structure and the content of each compound in the additive.

A content of the additive is preferably 0.1% by mass or more, more preferably 0.5% by mass or more, and still more preferably 1% by mass or more with respect to the total amount of the treatment liquid composition. When the content of the additive is within the above-described range, the occurrence of the pretreatment marks is reduced, and the color development is also improved. In addition, the content of the additive is preferably 25% by mass or less, more preferably 20% by mass or less, and still more preferably 15% by mass or less with respect to the total amount of the treatment liquid composition.

### 1.4. Organic Solvent

The treatment liquid composition according to the present embodiment may contain an organic solvent.

By containing the organic solvent, the fabric can be favorably dyed by dissolving or dispersing the dye in a part of the organic solvent remaining on the fabric when the dye is transferred to the fabric.

Examples of the organic solvent include glycols, glycol monoethers, nitrogen-containing solvents, and alcohols.

Examples of the glycols include ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, and 1,6-hexanediol.

Examples of the glycol monoethers include ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, and triethylene glycol monomethyl ether.

Examples of the nitrogen-containing solvents include 2-pyrrolidone, N-methyl-2-pyrrolidone, and N-ethyl-2-pyrrolidone.

Examples of the alcohols include methanol, ethanol, n-propyl alcohol, isopropyl alcohol, n-butanol, 2-butanol, tert-butanol, isobutanol, n-pentanol, 2-pentanol, 3-pentanol, and tert-pentanol.

The organic solvent preferably includes glycols, and more preferably includes 1,2-hexanediol.

A content of the organic solvent is preferably 5% by mass or more and 50% by mass or less, more preferably 10% by mass or more and 40% by mass or less, and still more preferably 15% by mass or more and 30% by mass or less with respect to the total amount of the treatment liquid composition. When the content of the organic solvent is within the above-described range, the occurrence of the pretreatment marks is reduced, and the color development of the printed matter is also improved.

### 1.5. Water

The treatment liquid composition according to the present embodiment contains water.

The water is evaporated and scattered by drying, after attaching the treatment liquid composition to the fabric. Examples of the water include pure water such as ion-exchanged water, ultrafiltration water, reverse osmosis water, and distilled water; and ultrapure water from which ionic impurities are removed as much as possible. In addition, water sterilized by irradiation with ultraviolet radiation, addition of hydrogen peroxide, or the like is preferable because growth of fungi and bacteria can be suppressed when the treatment liquid composition is stored for a long period of time.

A content of the water is preferably 30% by mass or more and 98% by mass or less, more preferably 40% by mass or more and 96% by mass or less, and still more preferably 50% by mass or more and 94% by mass or less with respect to the total amount of the treatment liquid composition. When the content of the water is within the above-described range, excessive increase in the viscosity of the treatment liquid composition can be prevented, and the viscosity can be adjusted within an appropriate range.

### 1.6. Other Components

The treatment liquid composition according to the present embodiment may contain a surfactant, a solubilizing agent, a thickening agent, a pH adjusting agent, an antioxidant, a preservative, an antifungal agent, a chelating agent, and the like (hereinafter, also referred to as “other components”).

Each content of the other components is, for example, 0.01% by mass or more and 5.0% by mass or less with respect to the total amount of the treatment liquid composition.

### 1.7. Method for Preparing Treatment Liquid Composition

The treatment liquid composition can be prepared by mixing each of the components in any order, and performing filtration or the like as necessary to remove impurities, foreign substances, and the like. As a mixing method for each of the components, a method of sequentially introducing each component into a container equipped with a stirring device such as a mechanical stirrer or a magnetic stirrer, and carrying out stirring and mixing is used. Examples of the filtration method include centrifugal filtration and filter filtration.

### 1.8. Physical Properties of Treatment Liquid Composition

### 1.8.1. Viscosity

A viscosity of the treatment liquid composition at 20° C. is preferably 1.5 mPa-s or more and 15.0 mPa-s or less, and more preferably 3.0 mPa-s or more and 13.0 mPa-s or less.

By setting the viscosity of the treatment liquid composition within the above-described range, the treatment liquid composition is less likely to migrate when the treatment liquid composition is attached to the fabric and dried, and thus the pretreatment marks can be reduced. In addition, the treatment liquid composition is likely to remain inside the fabric, and can exhibit favorable color development and reduce the discoloration over time.

The viscosity of the treatment liquid composition can be measured using a viscoelasticity tester MCR-301 (manufactured by Anton Paar GmbH) at 20° C., by increasing Shear Rate from 10 [s⁻¹] to 1000 [s⁻¹] and reading the viscosity at Shear Rate of 200.

### 1.8.2. Surface Tension

A surface tension of the treatment liquid composition at 25° C. is preferably 30 mN/m or more and 50 mN/m or less. When the surface tension of the treatment liquid composition at 25° C. is within the above-described range, the treatment liquid composition exhibits appropriate permeability and wettability with respect to the fabric. In addition, since the treatment liquid composition is easily absorbed uniformly by the fabric, a density difference in the amount of attachment occurring when applying the treatment liquid composition, that is, the occurrence of coating unevenness, can be suppressed.

The surface tension of the treatment liquid composition can be measured by using, for example, an automatic surface tension meter CBVP-Z (Kyowa Interface Science Co., Ltd.). Specifically, the measurement can be made by reading the surface tension when a platinum plate is wetted with the treatment liquid composition in an environment at 25° C.

### 2. COMPOSITION SET

A composition set according to one embodiment of the present disclosure contains the above-described treatment liquid composition for dye textile printing, and an ink jet ink composition (hereinafter, also referred to as “ink composition”).

The composition set according to the present embodiment is used for the purpose of obtaining a printed matter by first attaching the treatment liquid composition to a fabric and then performing textile printing with the ink composition on the fabric to which the treatment liquid composition is attached. Since the printed matter obtained in this manner is attached to the fabric with the above-described treatment liquid composition, the pretreatment marks caused by the treatment liquid composition are reduced, and the printed matter exhibits excellent color development. In addition, the discoloration of the printed matter over time is also reduced.

The treatment liquid composition for dye textile printing, contained in the composition set according to the present embodiment, is described in detail above, and thus the description thereof will be not be repeated here. Hereinafter, the ink jet ink composition contained in the composition set according to the present embodiment will be described.

### 2.1. Ink Jet Ink Composition

The ink jet ink composition is used when printing the fabric to which the above-described treatment liquid composition is attached. In the composition set according to the present embodiment, the ink jet ink composition may be only one type or may be a combination of two or more types.

The ink composition used in the present embodiment contains a disperse dye and water.

### 2.1.1. Disperse Dye

The ink jet ink composition contains a disperse dye as a dye. Since the ink composition contains a disperse dye, favorable color development can be obtained when the ink composition is printed on the fabric to which the treatment liquid composition is attached.

The disperse dye is usually in a form of particles, and is a coloring material that is dispersed in a dispersion medium by a dispersant. The disperse dye is usually a nonionic dye having a hydrophilic group and a moderately polar group.

Examples of the disperse dye include C.I. Disperse Yellow, C.I. Disperse Red, C.I. Disperse Blue, C.I. Disperse Orange, C.I. Disperse Violet, C.I. Disperse Green, C.I. Disperse Brown, and C.I. Disperse Black.

As the disperse dye, a sublimation dye is preferable. Among disperse dyes, the sublimation dye refers to a dye that is sublimated by heating.

Specific examples of the sublimation dye include C.I. Disperse Yellow 3, 7, 8, 23, 39, 51, 54, 60, 71, and 86; C.I. Disperse Orange 1, 1:1, 5, 20, 25, 25:1, 33, 56, and 76; C.I. Disperse Brown 2; C.I. Disperse Red 11, 50, 53, 55, 55:1, 59, 60, 65, 70, 75, 93, 146, 158, 190, 190:1, 207, 239, and 240; C.I. Vat Red 41; C.I. Disperse Violet 8, 17, 23, 27, 28, 29, 36, and 57; C.I. Disperse Blue 14, 19, 26, 26:1, 35, 55, 56, 58, 64, 64:1, 72, 72:1, 81, 81:1, 91, 95, 108, 131, 141, 145, and 359; and C.I. Solvent Blue 36, 63, 105, and 111.

In the present embodiment, from the viewpoint of obtaining more favorable dyeability for the fabric to which the treatment liquid composition is attached, and obtaining a printed matter exhibiting sufficient color development, a cyan dye, a red dye, or a yellow dye is preferable. From the viewpoint of obtaining further favorable dyeability and obtaining the printed matter exhibiting sufficient color development, C.I. Disperse Blue 359 is more preferable as the cyan dye; C.I. Disperse Red 60 is more preferable as the red dye; and C.I. Disperse Yellow 54 is more preferable as the yellow dye.

Regarding the disperse dye, one kind thereof may be used alone, or two or more kinds thereof may be used in combination.

A content of the disperse dye is preferably 0.05% by mass or more and 20% by mass or less with respect to the total amount of the ink composition.

### 2.1.2. Water

The ink jet ink composition contains water. The water is the same as in the treatment liquid composition, including the preferred aspect, and is the same as the description in the section of “1.5. Water”.

A content of the water is preferably 30% by mass or more and 80% by mass or less with respect to the total amount of the ink composition.

### 2.1.3. Dispersant

The ink jet ink composition may contain a dispersant. When the ink composition contains a dispersant, dispersibility of the disperse dye is improved, and thus clogging of an ink jet recording apparatus at the time of textile printing can be reduced.

The dispersant is not particularly limited, and examples thereof include sodium naphthalene sulfonate-formalin condensate and a resin. Sodium naphthalene sulfonate-formalin condensate is a compound obtained by subjecting a sulfonate having a naphthalene ring in the molecule to formalin-condensation, or a salt thereof. Regarding the dispersant, one kind thereof may be used alone, or two or more kinds thereof may be used in combination.

As the dispersant, it is preferable to contain a resin. Examples of the resin include a urethane resin, a styrene-acrylic resin, an acrylic resin, a fluororesin, a polyolefin resin, a rosin-modified resin, a terpene resin, a polyester resin, a polyamide resin, an epoxy resin, a vinyl chloride resin, a vinyl chloride-vinyl acetate copolymer, and an ethylene vinyl acetate-based resin. As the resin, from the viewpoint of excellent resistance to clogging, a urethane resin or a styrene-acrylic resin is preferable, and a styrene-acrylic resin is more preferable.

A content of the dispersant is preferably 3.0% by mass or more and 8.0% by mass or less with respect to the total amount of the ink composition. When the content of the dispersant is within the above-described range, the disperse dye can be stably dispersed.

### 2.1.4. Surfactant

The ink jet ink composition may contain a surfactant. The surfactant is not particularly limited, and examples thereof include an acetylene glycol-based surfactant, a fluorine-based surfactant, and a silicone-based surfactant. Regarding the surfactant, one kind thereof may be used alone, or two or more kinds thereof may be used in combination.

Examples of the acetylene glycol-based surfactant include 2,4,7,9-tetramethyl-5-decyne-4,7-diol and an alkylene oxide adduct thereof, and 2,4-dimethyl-5-decyn-4-ol and an alkylene oxide adduct thereof.

As the acetylene glycol-based surfactant, a commercially available product can also be used. Examples of the commercially available product include OLFINE (registered trademark) E series (product name manufactured by Nissin Chemical Industry Co., Ltd.) and SURFYNOL (registered trademark) series (product name manufactured by Air Products and Chemicals, Inc.).

Examples of the fluorine-based surfactant include a perfluoroalkyl sulfonic acid salt, a perfluoroalkyl carboxylic acid salt, a perfluoroalkyl phosphoric acid ester, a perfluoroalkyl ethylene oxide adduct, a perfluoroalkyl betaine, and a perfluoroalkylamine oxide compound.

As the fluorine-based surfactant, a commercially available product can also be used. Examples of the commercially available product include SURFLON (registered trademark) series (product name manufactured by AGC SEIMI CHEMICAL CO., LTD.).

Examples of the silicone-based surfactant include a polysiloxane-based compound and a polyether-modified organosiloxane.

As the silicone-based surfactant, a commercially available product can also be used. Examples of the commercially available product include BYK-306, BYK-307, BYK-333, BYK-341, BYK-345, BYK-346, BYK-347, BYK-348, and BYK-349 (all product names manufactured by BYK Japan K.K.).

A content of the surfactant is preferably 0.5% by mass or more and 5.0% by mass or less with respect to the total amount of the ink composition.

### 2.1.5. Water-Soluble Organic Solvent

The ink jet ink composition may contain a water-soluble organic solvent.

Examples of the water-soluble organic solvent include glycols, glycol monoethers, nitrogen-containing solvents, alcohols, and glycerin.

Examples of the glycols include ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, and 1,6-hexanediol.

Examples of the glycol monoethers include ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, and triethylene glycol monomethyl ether (methyl triglycol).

Examples of the nitrogen-containing solvents include 2-pyrrolidone, N-methyl-2-pyrrolidone, and N-ethyl-2-pyrrolidone.

Examples of the alcohols include methanol, ethanol, n-propyl alcohol, isopropyl alcohol, n-butanol, 2-butanol, tert-butanol, isobutanol, n-pentanol, 2-pentanol, 3-pentanol, and tert-pentanol.

Regarding the water-soluble organic solvent, one kind thereof may be used alone, or two or more kinds thereof may be used in combination.

Among the above, the glycerin, glycols, and glycol monoethers can mainly function as a penetrant and/or a moisturizer. The glycol monoethers tend to have strong properties as the penetrant, and the glycerin and glycols tend to have strong properties as the moisturizer.

A content of the water-soluble organic solvent is preferably 5% by mass or more and 30% by mass or less with respect to the total amount of the ink composition.

### 2.1.6. Other Components

The ink jet ink composition may contain a dissolution aid, a viscosity modifier, a pH adjuster, an antioxidant, a preservative, an antifungal agent, a corrosion inhibitor, a chelating agent for capturing metal ions that affect dispersion, and the like (hereinafter, also referred to as “other components of the ink composition”). Regarding the other components of the ink composition, one kind thereof may be used alone, or two or more kinds thereof may be used in combination.

Examples of the preservative include sodium pentachlorophenol, sodium 2-pyridinethiol-1-oxide, and 1,2-dibenzinethiazolin-3-one.

As the preservative, a commercially available product can also be used. Examples of the commercially available product include PROXEL (registered trademark) GXL (product name manufactured by Lonza). Regarding the preservative, one kind thereof may be used alone, or two or more kinds thereof may be used in combination.

A content of the other components of the ink composition is 0.01% by mass or more and 5.0% by mass or less with respect to the total amount of the ink composition.

### 2.2. Method for Producing Ink Jet Ink Composition

The ink jet ink composition is obtained by mixing the disperse dye, water, and, the other components as necessary in any order, and as necessary, filtering or the like to remove impurities. As a method of mixing each component, a method of sequentially adding the materials to a container equipped with a stirrer such as a mechanical stirrer and a magnetic stirrer, and stirring and mixing thereof is suitably used. As the filtration method, centrifugal filtration, filter filtration and the like can be performed depending on the necessity.

In addition, in the ink composition, in order to disperse the disperse dye more favorably, a dye dispersion liquid may be prepared by mixing the disperse dye, the dispersant, and a part of water in any order in advance, and dispersing the mixture with a paint shaker or the like. The ink composition can be prepared by using the prepared dye dispersion and the remaining components.

### 3. TEXTILE PRINTING METHOD

### 3.1. Treatment Liquid Composition Attaching Step

A textile printing method according to one embodiment of the present disclosure includes a treatment liquid composition attaching step of attaching the treatment liquid composition to a fabric.

By passing through the present step, the fabric to which the treatment liquid composition is attached can be obtained, and by attaching the ink jet ink composition to this fabric, the ink composition exhibits favorable color development, and the discoloration over time is reduced.

The textile printing method can be applied to various fabrics, and satisfactory textile printing can be performed.

Examples of the fabric include natural fibers such as cotton, hemp, wool, leather, and silk; synthetic fibers such as polypropylene, polyester, acetate, triacetate, polyamide, acrylic, and polyurethane; and biodegradable fibers such as polylactic acid. In addition, the fabric may be a blended fiber of the above-described fibers.

In the present embodiment, the fabric preferably contains a fiber having a hydroxy group, and more preferably is cotton. The above-described fiber having a hydroxy group may be a blended fiber. By containing the fiber having a hydroxy group in the fabric, it is possible to obtain a printed matter exhibiting excellent color development and maintaining the texture of the fabric.

Examples of a form of the fabric include a woven fabric, a knitted fabric, a nonwoven fabric, cloth, garments, and other clothing ornaments. Examples of garments and other clothing ornaments include sewn T-shirts, handkerchiefs, scarves, towels, handbags, and fabric furniture such as bags, curtains, sheets, bedspreads, and wallpaper; cloth before and after cutting as sections to be sewn. Examples of the form of the fabric before and after cutting include a long roll-shaped product, a product cut into a predetermined size, and a product having the shape of a manufactured product. Regarding the fabric, it is sufficient that the treatment liquid composition is attached to the fabric, and a fabric to which the treatment liquid composition is applied in advance may also be used.

It is preferable that a basis weight of the fabric is, for example, 1.0 oz or more and 10.0 oz or less. When the basis weight of the fabric is within the above-described range, the printing can be favorably performed.

As the fabric, an uncolored white fabric and a fabric previously colored with a dye can be used. In the white fabric, an optical brightening agent or the like may be used in order to maintain or improve the visual whiteness. The fluorescent brightener or the like, used during the manufacturing, may remain in the fabric, and it is considered that sodium ions or the like, contained in the remaining fluorescent brightener or the like, are the cause of the occurrence of the pretreatment marks. Since the treatment liquid composition used in the present embodiment can reduce the occurrence of the pretreatment marks, it is possible to obtain a printed matter with little pretreatment marks even when the fabric treated with the optical brightening agent or the like is used. Therefore, the textile printing method according to the present embodiment is particularly suitable when the fabric is white cotton and the form of the fabric is a T-shirt. In addition, even when using the fabric previously colored, the printed matter exhibits more favorable color development by performing the pretreatment using the treatment liquid composition used in the present embodiment.

Examples of the dye with which the fabric is previously colored include water-soluble dyes such as an acidic dye and a basic dye; disperse dyes used in combination with dispersants; reactive dyes; and solvent dyes. When a cotton fabric is used as the fabric, it is preferable to use a disperse dye and a reactive dye suitable for dyeing cotton, and a reactive dye is more preferable.

Regarding an amount of attachment of the treatment liquid composition to the fabric, for example, it is preferable to attach the treatment liquid composition such that the amount of attachment is 0.02 g/cm² or more and 0.5 g/cm² or less, and it is more preferable to attach the treatment liquid composition such that the amount of attachment is 0.02 g/cm² or more and 0.3 g/cm² or less. When the amount of attachment of the treatment liquid composition is within the above-described range, the treatment liquid composition can be more uniformly attached to the fabric, so that aggregation unevenness of the image in the printed matter can be further suppressed, and the color development can be favorably exhibited.

A method of attaching the treatment liquid composition to the fabric is not particularly limited as long as the treatment liquid composition can be attached to at least a part of a region of the fabric. Examples of the method of attaching the treatment liquid composition include an immersion application method in which the fabric is immersed in the treatment liquid composition, a roller application method in which the treatment liquid composition is applied by a mangle roller, a roll coater, or the like, a spray application method in which the treatment liquid composition is sprayed by a spray device or the like, and an ink jet application method in which the treatment liquid composition is attached by an ink jet method. The application method may be used alone or in combination of two or more.

In the present embodiment, it is preferable to use the roller application method in which the treatment liquid composition is applied by a mangle roller, a roll coater, or the like. By using the roller application method, the amount of attachment of the treatment liquid composition can be adjusted, and the treatment liquid composition can be uniformly applied onto the fabric.

### 3.2. Drying Step

The textile printing method according to the present embodiment preferably includes, after the treatment liquid composition attaching step of attaching the treatment liquid composition to the fabric, a drying step of drying the treatment liquid composition attached to the fabric. In the drying step, a drying method by heating is preferably used from the viewpoint of improving the amount of attachment of the treatment liquid composition to the fabric and improving the drying rate. The fabric to which the treatment liquid composition is attached may be pre-heated before the drying step.

Examples of a heating method in the drying step include a heat press method, a normal-pressure steam method, a high-pressure steam method, and a thermofix method. Among the above, a heat press method of simultaneously applying heat and pressure is preferable. By using the heat press method, when moisture in the treatment liquid composition evaporates, steam escapes from a portion where the pressure is not applied, so that the residual components and the carbonates in the fabric also migrate to the same portion at the same time and are easily localized. Therefore, the textile printing method according to the present embodiment is more effective. In addition, a heat source at the time of heating is not particularly limited, and for example, warm air, an infrared lamp, a microwave, or the like can be used.

A drying temperature is preferably 300° C. or lower, more preferably 250° C. or lower, and still more preferably 180° C. or lower. When the drying temperature is within the above-described range, even when the fabric is dyed with a dye in advance, it is possible to suppress sublimation of the dye due to the heating and drying, and to reduce the discoloration of the fabric color. In addition, the drying temperature is preferably 50° C. or higher, more preferably 100° C. or higher, and still more preferably 110° C. or higher.

A heating time during the drying is preferably, for example, 1 second or longer and 5 minutes or shorter. When the heating time is within the above-described range, the volatile components such as the water and the organic solvent can be suitably volatilized from the fabric, and thus damage to the fabric can also be reduced.

### 3.3. Ink Composition Attaching Step

The textile printing method according to the present embodiment preferably includes, after the treatment liquid composition attaching step or the drying step, an ink composition attaching step of attaching an ink composition to the fabric to which the treatment liquid composition is attached. As the ink composition to be attached to the fabric, the above-described ink jet ink composition can be used. In addition, the ink composition attaching step can use a textile printing method by an ink jet method.

The ink jet textile printing method is a method of attaching the ink composition to the fabric to which the treatment liquid composition is attached, by an ink jet method. By the ink jet method, the discharge amount can be controlled, and a fine pattern or image can be formed. In addition, the ink jet textile printing method can be adopted regardless of the basis weight of the fabric or the type of the fabric, and can perform favorable textile printing with small front and back color difference even on a thick fabric. Examples of the ink jet textile printing method include an indirect textile printing recording method and a direct textile printing recording method.

In the indirect textile printing recording method, what is attached to the fabric is not strictly the ink composition itself, but only some of the components contained in the ink composition, such as the disperse dye. In the present specification, “attaching the ink composition to the fabric” includes that only some of the components contained in the ink composition are attached.

### 3.3.1. Ink Jet Recording Apparatus

An ink jet recording apparatus used for the ink jet textile printing method has at least an ink storage body storing an ink composition and a recording head coupled to this ink storage body, and the ink jet recording apparatus is not particularly limited as long as it can discharge the ink composition from the recording head and form an image on a fabric having the treatment liquid composition attached thereto, or a transfer paper which is an intermediate transfer medium.

As the ink jet recording apparatus, both a serial type and a line type can be used. In any type of the ink jet recording apparatus, an ink jet head is mounted, and it is possible to form a predetermined image by attaching ink to a fabric or an intermediate transfer medium by discharging ink droplets from a nozzle hole of the ink jet head at a predetermined timing and a predetermined volume while changing a relative positional relationship between the fabric or the intermediate transfer medium and the ink jet head.

In general, in a serial type ink jet recording apparatus, a transport direction of a recording medium and a reciprocating operation direction of the ink jet head intersect each other, and the relative positional relationship between the recording medium and the ink jet head is changed by a combination of the reciprocating operation of the ink jet head and the transport operation of the recording medium. At this time, generally, a plurality of nozzle holes are arranged in the ink jet head, and the nozzle holes are formed along the transport direction of the recording medium. In addition, the plurality of nozzle rows may be formed in the ink jet head depending on the type and number of ink compositions.

In addition, in general, in a line type ink jet recording apparatus, the ink jet head does not perform a reciprocating operation, and the relative positional relationship between the recording medium and the ink jet head is changed by transporting the recording medium. Also at this time, generally, a plurality of nozzle holes are arranged in the ink jet head, and a row of the nozzle holes is formed along a direction intersecting the transport direction of the recording medium.

### 3.3.2. Indirect Textile Printing Recording Method

In the indirect textile printing recording method, the ink composition containing the disperse dye such as the sublimation dye is discharged by a liquid ejecting head that is a recording head and attached to an intermediate transfer medium, a surface of the intermediate transfer medium, to which the ink composition is attached, and a surface of the fabric, to which the treatment liquid composition is attached, are heated in a state of facing each other, and the disperse dye contained in the ink composition is transferred to the fabric to which the treatment liquid composition is attached. With the indirect textile printing recording method, the form of the fabric is not limited, and the printing can be performed well.

As the intermediate transfer medium, for example, paper such as plain paper, a recording medium provided with an ink receiving layer, or the like can be used. The recording medium provided with the ink receiving layer is referred to as, for example, ink jet paper, coated paper, or the like. As the recording medium provided with the ink receiving layer, paper provided with an ink receiving layer containing inorganic particles such as silica is more preferable. By providing the ink receiving layer containing inorganic particles, the intermediate recording material in which bleeding or the like is suppressed on the recording surface can be obtained in the process of drying the ink composition applied to the intermediate transfer medium. In addition, when the recording medium is provided with such an ink receiving layer, the disperse dye is more likely to be retained on the surface of the recording surface, and the sublimation of the disperse dye can be performed more efficiently in the subsequent transfer step.

In the transfer step, the recording surface to which the ink composition of the intermediate transfer medium is attached and the fabric surface to which the treatment liquid composition is attached are heated in a state of facing each other, the disperse dye contained in the ink composition is sublimated, and the disperse dye is transferred to the fabric to which the treatment liquid composition is attached. As a result, a printed matter in which the disperse dye is transferred to the fabric to which the treatment liquid composition is attached is obtained.

In the present step, the intermediate transfer medium to which the ink composition is attached may be heated in a state of being opposed to the fabric to which the treatment liquid composition is attached, and it is more preferable to heat the intermediate transfer medium and the fabric in a state of being in close contact with each other. As a result, a clearer image can be recorded on the fabric.

Examples of a heating method include a heat press method by dry heat, a normal-pressure steam method by dry heat, a high-pressure steam method, and a thermofix method. The fabric to which the ink composition is attached may be immediately subjected to a heat treatment, or the heat treatment may be performed after a predetermined time is elapsed. The heating method is preferably a dry heat method. By the dry heat, there is a tendency that the printed matter tends to exhibit favorable color development and maintain the texture required for the printed matter.

As the heating method, a heat press method by dry heat is preferably used. Normally, in the heat press by dry heat, when heating, moisture contained in the fabric is vaporized from the unpressed portion. At this time, the carbonate such as sodium carbonate and potassium carbonate, generated in the fabric, may migrate and be localized in the unpressed portion, and may be generated as pretreatment marks on the fabric surface. Since the treatment liquid composition in the present embodiment contains the compound having a polyoxyalkylene structure, the viscosity of the treatment liquid composition is improved. Therefore, even when the heat press is used, the migration of the treatment liquid composition in the fabric is small, the localization of the carbonate is also reduced, and thus the occurrence of the pretreatment marks is reduced.

A heating temperature is preferably 160° C. or higher and 220° C. or lower, and more preferably 190° C. or higher and 210° C. or lower. When the heating temperature is within the above-described range, an energy required for the transfer can be further reduced, and thus productivity of the printed matter tends to be more excellent. In addition, the color development of the printed matter tends to be more excellent.

A heating time in the transfer step depends on the heating temperature, but is preferably 30 seconds or longer and 120 seconds or shorter, and more preferably 40 seconds or longer and 90 seconds or shorter. When the heating time in the transfer step is within the above-described range, the energy required for the transfer can be reduced, and thus the productivity of the printed matter tends to be more excellent. In addition, the color development of the printed matter tends to be more excellent.

An amount of attachment of the ink composition attached to the fabric by the transfer is preferably, for example, 1.5 mg/cm² or more and 6.0 mg/cm² or less per unit area of the fabric. When the amount of attachment of the ink composition is within the above-described range, the color development of the image or the like formed by the textile printing is improved, and the ink composition attached to the fabric is suitably dried, so that the occurrence of bleeding in the image or the like is reduced.

### 3.3.3. Direct Textile Printing Recording Method

In the direct textile printing recording method, the ink composition is ejected from the recording head, and the ink composition is directly attached to the fabric to which the treatment liquid composition obtained by the treatment liquid composition attaching step is attached. In the direct textile printing recording method, since the intermediate transfer medium is not used, on-demand performance is excellent, and it is possible to correspond to multi-variety small-quantity production.

In the direct textile printing recording method, the ink composition may be further attached to a region to which the ink composition has already been attached.

In the direct textile printing method, the maximum amount of attachment to the fabric is preferably 50 mg/cm² or more and 200 mg/cm² or less, and more preferably 80 mg/cm² or more and 150 mg/cm² or less. When the maximum attachment amount is within the above-described range, favorable color development is exhibited. In addition, there is a tendency that aggregation unevenness of the image in the printed matter is reduced.

In the present step, it is preferable to perform heating when the ink composition is attached to the fabric to which the treatment liquid composition is attached. By heating at the time of attaching the ink composition, a clearer image can be recorded on the fabric.

Examples of a heating method include a heat press method, a normal-pressure steam method, a high-pressure steam method, and a thermofix method. In addition, a heat source at the time of heating is not particularly limited, and for example, warm air, an infrared lamp, a microwave, or the like can be used.

A surface temperature of the fabric during the heating is preferably 60° C. or higher and 180° C. or lower. When the surface temperature of the fabric is within the above-described range, damage to the ink jet head or the fabric can be reduced. In addition, the ink composition is easily spread uniformly on the fabric and easily permeates the fabric.

The surface temperature of the fabric can be measured using, for example, a non-contact thermometer (“IT2-80”, product name manufactured by Keyence Corporation).

As a heating time in the direct textile printing recording method, for example, it is preferably 5 seconds or longer and 5 minutes or shorter. When the heating time is within the above-described range, the fabric can be suitably heated while reducing the damage to the ink jet head or the fabric.

### 3.4. Cleaning Step

In the textile printing method according to the present embodiment, a cleaning step may be included after the treatment liquid composition is attached to the fabric, as necessary. When the textile printing method includes the cleaning step, the treatment liquid composition and other components not attached to the fabric can be removed.

### 4. EXAMPLES

Hereinafter, the present disclosure will be described in more detail with reference to examples, but the present disclosure is not limited to these examples. Hereinafter, “%” is based on mass unless otherwise specified.

### 4.1. Preparation of Treatment Liquid Composition for Dye Textile Printing

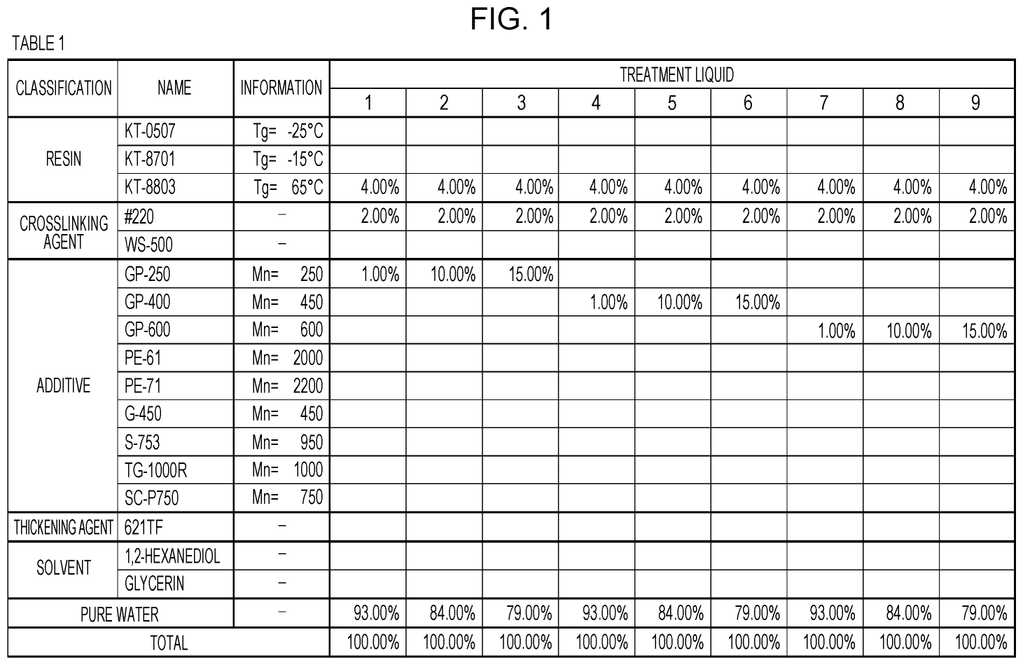

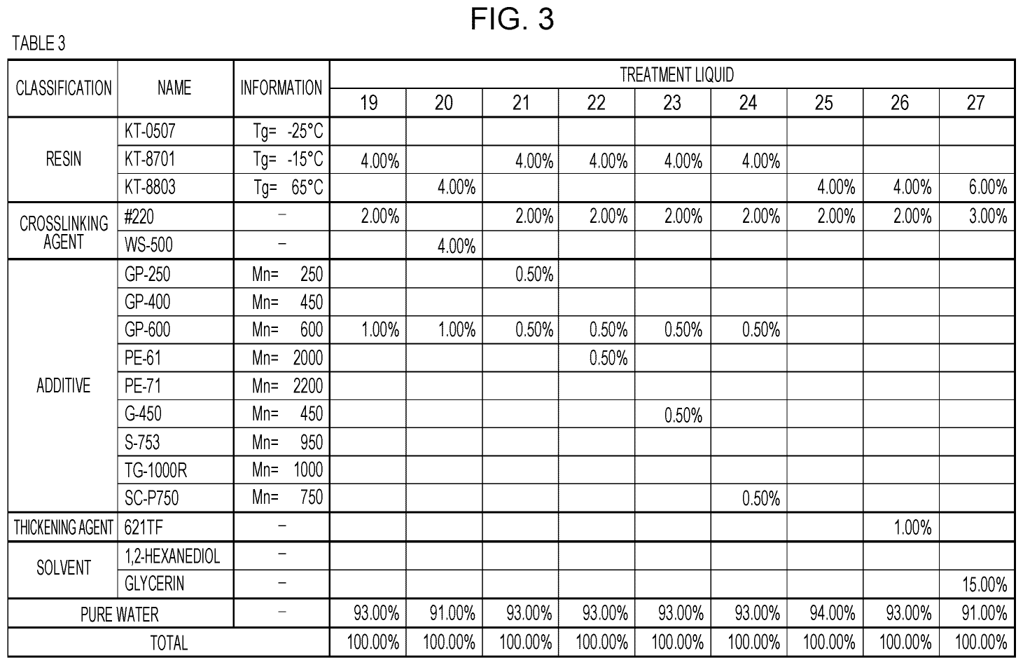

Each component was put into a mixing container so as to have the formulation (unit: % by mass) shown in Table 1 (FIG. 1) to Table 3 (FIG. 3), and mixed and stirred with a magnetic stirrer, and then filtered with a membrane filter having a pore size of 5 μm to obtain treatment liquids 1 to 27 as the treatment liquid composition.

Each component in Table 1 to Table 3 is as follows.

### Resin

KT-0507: product name “ELITEL (registered trademark) KT-0507”, manufactured by Unitika, Ltd., polyester resin
KT-8701: product name “ELITEL (registered trademark) KT-8701”, manufactured by Unitika, Ltd., polyester resin
KT-8803: product name “ELITEL (registered trademark) KT-8803”, manufactured by Unitika, Ltd., polyester resin

### Crosslinking Agent

#220: product name “FIXER #220”, manufactured by Murayama Chemical Laboratory Co., Ltd., isocyanate compound
WS-500: product name “EPOCROS (registered trademark) WS-500”, manufactured by Nippon Shokubai Co., Ltd., oxazoline compound

### Additive

GP-250: product name “SANNIX (registered trademark) GP-250”, manufactured by Sanyo Chemical Industries, Ltd., polyoxypropylene-glyceryl ether
GP-400: product name “SANNIX (registered trademark) GP-400”, manufactured by Sanyo Chemical Industries, Ltd., polyoxypropylene-glyceryl ether
GP-600: product name “SANNIX (registered trademark) GP-600”, manufactured by Sanyo Chemical Industries, Ltd., polyoxypropylene-glyceryl ether
PE-61: product name “NEWPOL (registered trademark) PE-61”, manufactured by Sanyo Chemical Industries, Ltd., polyoxyethylene-polyoxypropylene block polymer
PE-71: product name “NEWPOL (registered trademark) PE-71”, manufactured by Sanyo Chemical Industries, Ltd., polyoxyethylene-polyoxypropylene block polymer
G-450: product name “UNIOX (registered trademark) G-450”, manufactured by NOF CORPORATION, polyoxyethylene-glyceryl ether
S-753: product name “WILBRIDE (registered trademark) S-753”, manufactured by NOF CORPORATION, polyoxybutylene-polyoxyethylene-polyoxypropylene glyceryl ether
TG-1000R: product name “UNIOL (registered trademark) TG-1000R”, manufactured by NOF CORPORATION, polyoxypropylene-glyceryl ether
SC-P750: product name, manufactured by Sakamoto Yakuhin Kogyo Co., Ltd., polyoxypropylene-polyglyceryl ether Thickening Agent
621TF: product name “SN Thinner 621TF”, manufactured by SAN NOPCO LIMITED, urethane-modified polyether Organic Solvent
1,2-hexanediol
Glycerin

### 4.2. Preparation of Ink Jet Ink Composition

Each component was put into a mixing container so as to have the formulation (unit: % by mass) shown in Table 4, and mixed and stirred with a magnetic stirrer for 2 hours, and then filtered with a membrane filter having a pore size of 5 μm to obtain an ink jet ink composition (hereinafter, also referred to as “C ink”).

Each component in Table 4 is as follows.

### Disperse Dye

Disperse Blue 359: C.I. Disperse Blue 359 (commercially available product)

### Water-Soluble Organic Solvent

Propylene glycol
Glycerin
Methyl Triglycol

### Surfactant

BYK-348: product name, manufactured by BYK Japan K.K., silicone-based surfactant

### 4.3. Production of Printed Matter

4.3.1. Production of Fabric to which Treatment Liquid Composition was Attached

Each of the treatment liquids 1 to 27 as the treatment liquid composition was attached to a fabric to obtain a fabric to which the treatment liquid composition was attached.

Specifically, as the fabric, a white cotton braid #4000 (product name, manufactured by TOYOBO Co., Ltd.) was used. The white cotton braid was immersed in the treatment liquid composition, and the treatment liquid composition was attached thereto with a wet-pickup rate of 80% using a mangle roller. Thereafter, the white cotton braid was dried at 140° C. for 2 minutes, and then further dried at 170° C. for 1 minute to obtain a fabric to which the treatment liquid composition was attached.

The wet-pickup rate (S) was calculated by the following expression (1).

$$S ( \% ) = [ ( A - B ) / B ] \times 100 \qquad ( 1 )$$

In the expression (1), S represents the wet-pickup rate (%), A represents a mass (g) of the fabric to which the treatment liquid composition was attached, and B represents a mass (g) of the fabric before the treatment liquid composition was attached.

4.3.2. Production of Intermediate Recording Medium to which Ink Composition was Attached

The C ink prepared above was filled in a cartridge of an ink jet printer PX-G930 (product name, manufactured by Seiko Epson Corporation). Thereafter, an image having a fill pattern was formed at a surface of coated paper (TRANSJET Sportsline 1254, product name manufactured by Cham Paper Group) as an intermediate transfer medium, under the condition that the ink jet amount was 12 mg/inch² at a resolution of 720 dpi×720 dpi and an ink discharge amount of 100% Duty. As a result, an intermediate recording medium to which the ink composition was attached was obtained.

### 4.3.3. Textile Printing

A cotton braid to which the treatment liquid composition obtained in the section of “4.3.1. Production of Fabric to which Treatment Liquid Composition was Attached” was attached was heat-transferred under the conditions of a temperature of 200° C., a pressure of 4.2 N/cm², and 60 seconds using a heat press machine TP-608M (product name manufactured by Taiyo Seiki Co., Ltd.) to a surface of the intermediate recording medium, at which the image was formed and to which the ink composition obtained in the section of “4.3.2. Production of Intermediate Recording Medium to which Ink Composition was Attached” was attached, and thus, each of printed matters that were fabrics to which the C ink was attached was obtained.

### 4.4. Evaluation of Printed Matter

### 4.4.1. Color Developing Property

A color development density (hereinafter, also referred to as “OD value”) of the printed matters of Examples 1 to 24 and Comparative Examples 1 to 3 obtained by the above-described textile printing with respect to the C ink was measured immediately after the textile printing using a fluorescent spectrophotometer FD-7 (manufactured by Konica Minolta, Inc.). The measurement conditions were as follows. The measurement was carried out under an environment of room temperature of 25° C.

### Measurement Conditions

Observation light source: D65
Observation field of view: 2 degrees
Concentration status: T
Polarizing filter: Not installed

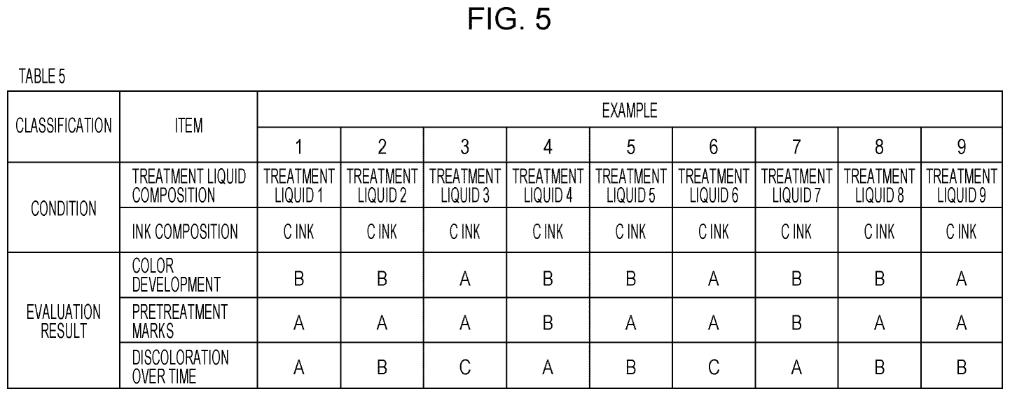

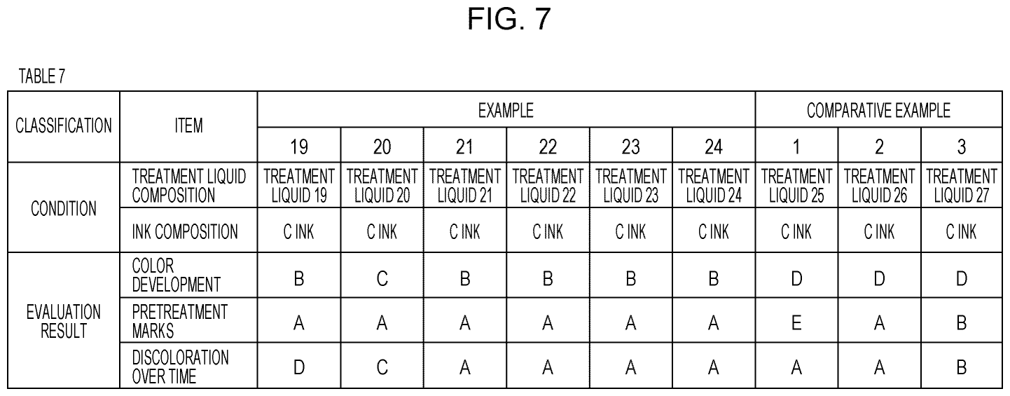

In addition, the evaluation criteria were as follows, and the evaluation results are shown in Table 5 (FIG. 5) to Table 7 (FIG. 7). The color development was evaluated to be favorable as rated C or higher.

### Evaluation Criteria

A: OD value was 1.3 or more.
B: OD value was 1.2 or more and less than 1.3.
C: OD value was 1.1 or more and less than 1.2.
D: OD value was 1.0 or more and less than 1.1.
E: OD value was less than 1.0.

### 4.4.2. Pretreatment Marks

The pretreatment was carried out on the fabric using the treatment liquids 1 to 27 as the treatment liquid composition, and the printed matter after the heat transfer was evaluated. Specifically, as the fabric, a white T-shirt (00085-CVT, product name manufactured by TOMS CO., LTD.) was used. The white T-shirt was immersed in the treatment liquid composition, and the treatment liquid composition was attached thereto with a wet-pickup rate of 80% using a mangle roller. The white T-shirt was dried at 140° C. for 2 minutes, and then further dried at 170° C. for 1 minute to obtain a white T-shirt to which the treatment liquid composition was attached.

A surface of the intermediate recording medium produced in the section of “4.3.2. Production of Intermediate Recording Medium to which Ink Composition was Attached”, at which an image was formed, was heat-transferred to the white T-shirt to which the treatment liquid composition was attached to obtain a printed matter to which the C ink was attached. The heat transfer was carried out under the conditions of a temperature of 200° C., a pressure of 4.2 N/cm², and a transfer time of 60 seconds using a heat press machine TP-608M (product name manufactured by Taiyo Seiki Co., Ltd.).

As a result, the printed matters of Examples 1 to 24 and Comparative Examples 1 to 3 were obtained.

The pretreatment marks were evaluated using the printed matters obtained in Examples 1 to 24 and Comparative Examples 1 to 3. Specifically, the L value, a* value, and b* value of the pretreated portion and the untreated portion of the printed matter were measured using a fluorescent spectrophotometer FD-7 (manufactured by Konica Minolta, Inc.). A color change ΔE value was calculated using the obtained L value, a* value, and b* value. The measurement was carried out under the same conditions as in the section of “4.4.1. Color Developing Property” at room temperature of 25° C.

The evaluation criteria were as follows, and the evaluation results are shown in Table 5 (FIG. 5) to Table 7 (FIG. 7).

### Evaluation Criteria

A: ΔE was 0 or more and less than 1.0.
B: ΔE was 1.0 or more and less than 2.0.
C: ΔE was 2.0 or more and less than 3.0.
D: ΔE was 3.0 or more and less than 4.0.
E: ΔE was 4.0 or more.

### 4.4.3. Discoloration Over Time

An OD value of a recording surface of the printed matter immediately after the printing was measured using a fluorescent spectrophotometer FD-7 (manufactured by Konica Minolta, Inc.). In addition, the recording surface of the printed matter was measured in the same manner on the day after the printing, and the change rate of the OD value after the lapse of time (hereinafter, also referred to as “rate of discoloration over time”) was calculated. The measurement was carried out under the same conditions as in the section of “4.4.1. Color Developing Property” at room temperature of 25° C.

The rate of discoloration over time was calculated by the following expression (2).

$$Rate of discoloration over time = ( OD value on day after printing ) / ( OD value immediately after printing ) - 1 \qquad ( 2 )$$

The evaluation criteria were as follows, and the evaluation results are shown in Table 5 (FIG. 5) to Table 7 (FIG. 7).

### Evaluation Criteria

A: rate of discoloration over time was −1% or more.
B: rate of discoloration over time was −2% or more and less than −1%.
C: rate of discoloration over time was −4% or more and less than −2%.
D: rate of discoloration over time was −6% or more and less than −4%.
E: rate of discoloration over time was less than −6%.

### 4.4.4. Evaluation Results

The following matters were found from Examples and Comparative Examples.

In Examples of the treatment liquid composition for dye textile printing containing the resin, the crosslinking agent, the additive, and water, in which the additive includes a compound having a polyoxyalkylene structure, and the compound having a polyoxyalkylene structure is one or more selected from a polyoxyalkylene-glyceryl ether, a polyoxyalkylene-polyglyceryl ether, and a polyoxyalkylene block polymer, the results of the evaluation items of the color developing property and the pretreatment marks were favorable.

On the other hand, in Comparative Examples that did not satisfy the above-described conditions, any result of the color developing property or the pretreatment marks was not favorable.

By comparing Example 1 with Comparative Example 1, the treatment liquid composition containing the additive exhibited favorable color development in the printed matter, and the occurrence of the pretreatment marks was reduced.

In addition, by comparing Example 1 with Comparative Examples 2 and 3, the printed matter containing, as the additive, the compound having a polyoxyalkylene structure exhibited favorable color development.

From Examples 1, 10, and 24, when one or more selected from the polyoxyalkylene-glyceryl ether, the polyoxyalkylene-polyglyceryl ether, and the polyoxyalkylene block polymer were contained as the additive, the printed matter exhibited favorable color development, and the occurrence of the pretreatment marks was reduced.

From Examples 1 to 9, when the content of the compound having a polyoxyalkylene structure was within a predetermined range, the printed matter tended to exhibit favorable color development and reduce the pretreatment marks.

From Examples 1, 10, and 11, when the additive had a predetermined number or more of hydroxy groups, the printed matter tended to exhibit favorable color development.

From Examples 12 and 13, when the number of carbon atoms in the oxyalkylene group of the compound having a polyoxyalkylene structure was within a predetermined range, the printed matter tended to exhibit favorable color development and reduce the occurrence of the pretreatment marks.

From Example 13, when the additive had a polyoxyalkylene structure with oxyalkylene groups having different numbers of carbon atoms in the molecule, the printed matter exhibited favorable color development and the discoloration over time was reduced. In addition, the occurrence of the pretreatment marks tended to be reduced.

From Examples 1 and 14, when the number-average molecular weight of the compound having a polyoxyalkylene structure was within a predetermined range, the printed matter exhibited favorable color development and the discoloration over time was reduced. In addition, the occurrence of the pretreatment marks tended to be reduced.

From Examples 1 and 15, when the organic solvent was further contained, the printed matter exhibited favorable color development and the discoloration over time was reduced. In addition, the occurrence of the pretreatment marks tended to be reduced.

From Examples 16 and 17, when the content of the resin was within a predetermined range in terms of solid content, the occurrence of the pretreatment marks on the printed matter was reduced, and the tendency of the discoloration over time was also reduced.

In addition, from Examples 16 and 17, when the content of the crosslinking agent was within a predetermined range in terms of solid content, the occurrence of the pretreatment marks on the printed matter was reduced, and the tendency of the discoloration over time was also reduced.

From Examples 1, 18, and 19, when the glass transition temperature of the resin was a predetermined value or higher, the occurrence of the pretreatment marks tended to be reduced.

From Examples 1 and 20, when the crosslinking agent was an isocyanate compound and had an isocyanurate skeleton in the structure, the printed matter tended to exhibit favorable color development and reduce the discoloration over time.

From Examples 21 to 24, in various combinations of the polyoxyalkylene-glyceryl ether, the polyoxyalkylene-polyglyceryl ether, and the polyoxyalkylene block polymer as the additive, the occurrence of the pretreatment marks was reduced, and the discoloration of the printed matter over time was also reduced.

The present disclosure is not limited to the above-mentioned embodiment, and various modifications are possible. For example, the present disclosure includes a configuration substantially the same as the configuration described in the embodiment, for example, a configuration having the same function, method, and result, or a configuration having the same object and effect. In addition, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. In addition, the present disclosure includes configurations in which a known technology is added to the configurations described in the embodiments.

The following contents are derived from the above-described embodiments and modification examples.

A treatment liquid composition for dye textile printing, containing:
a resin;
a crosslinking agent;
an additive; and
water, in which
the additive includes a compound having a polyoxyalkylene structure, and
the compound having a polyoxyalkylene structure is one or more selected from a polyoxyalkylene-glyceryl ether, a polyoxyalkylene-polyglyceryl ether, and a polyoxyalkylene block polymer.

According to the treatment liquid composition for dye textile printing, since the additive includes, as the compound having a polyoxyalkylene structure, one or more selected from the polyoxyalkylene-glyceryl ether, the polyoxyalkylene-polyglyceryl ether, and the polyoxyalkylene block polymer, the viscosity of the treatment liquid composition is improved, the migration and localization of potassium ions and sodium ions that are causes of the pretreatment marks are reduced, and the occurrence of the pretreatment marks can be reduced. In addition, the dye is easily dissolved or decomposed by the additive, and the dye can penetrate into the inside of the fabric, so that the printed matter exhibits favorable color development.

In the above-described treatment liquid composition for dye textile printing, the compound having a polyoxyalkylene structure may have 2 or more and 4 or less carbon atoms in an oxyalkylene group.

According to the treatment liquid composition for dye textile printing, when the number of carbon atoms in the oxyalkylene group is 2 or more and 4 or less in the compound having a polyoxyalkylene structure, the printed matter exhibits favorable color development, and the pretreatment marks are reduced.

In the above-described treatment liquid composition for dye textile printing, the additive may include the compound having a polyoxyalkylene structure, which has oxyalkylene groups having different numbers of carbon atoms in a molecule.

According to the treatment liquid composition for dye textile printing, when the compound having a polyoxyalkylene structure has oxyalkylene groups having different numbers of carbon atoms in the molecule, the printed matter exhibits favorable color development and the discoloration over time is reduced. In addition, the occurrence of the pretreatment marks is also reduced.

In the above-described treatment liquid composition for dye textile printing, the additive may include a compound having three or more hydroxy groups.

According to the treatment liquid composition for dye textile printing, when the additive includes the compound having three or more hydroxy groups, the printed matter exhibits favorable color development.

In the above-described treatment liquid composition for dye textile printing, the number-average molecular weight of the compound having a polyoxyalkylene structure may be 250 or more and 1,000 or less.

According to the treatment liquid composition for dye textile printing, when the number-average molecular weight of the compound having a polyoxyalkylene structure is 250 or more and 1,000 or less, the printed matter exhibits favorable color development and the discoloration over time is reduced. In addition, the occurrence of the pretreatment marks is reduced.

In the above-described treatment liquid composition for dye textile printing, the resin may be a polyester resin.

According to the treatment liquid composition for dye textile printing, when the resin is a polyester resin, the printed matter exhibits favorable color development and texture.

In the above-described treatment liquid composition for dye textile printing, the glass transition temperature of the resin may be 25° C. or higher.

According to the treatment liquid composition for dye textile printing, when the glass transition temperature of the resin is 25° C. or higher, the printed matter exhibits favorable color development, and the occurrence of the pretreatment marks is reduced.

In the above-described treatment liquid composition for dye textile printing, the content of the resin may be 2% by mass or more and 20% by mass or less in terms of solid content with respect to the total amount of the treatment liquid composition for dye textile printing.

According to the treatment liquid composition for dye textile printing, the occurrence of the pretreatment marks is reduced. In addition, the discoloration of the printed matter over time is also reduced.

In the above-described treatment liquid composition for dye textile printing, the crosslinking agent may be an isocyanate compound.

According to the treatment liquid composition for dye textile printing, the printed matter exhibits favorable color development and the discoloration over time is reduced.

In the above-described treatment liquid composition for dye textile printing, the crosslinking agent may be an isocyanate compound which has an isocyanurate skeleton in the structure.

According to the treatment liquid composition for dye textile printing, the printed matter exhibits favorable color development and the discoloration over time is reduced.

In the above-described treatment liquid composition for dye textile printing, the content of the crosslinking agent may be 1% by mass or more and 3% by mass or less in terms of solid content with respect to the total amount of the treatment liquid composition for dye textile printing.

According to the treatment liquid composition for dye textile printing, the printed matter exhibits favorable color development and the discoloration over time is reduced.

The above-described treatment liquid composition for dye textile printing may further contain an organic solvent.

According to the treatment liquid composition for dye textile printing, the printed matter exhibits favorable color development and the discoloration over time is reduced. In addition, the occurrence of the pretreatment marks is reduced.

The composition set contains the above-described treatment liquid composition for dye textile printing, and an ink jet ink composition, in which the ink jet ink composition may contain a disperse dye and water.

According to the composition set, the printed matter exhibits favorable color development and the discoloration over time is reduced. In addition, the occurrence of the pretreatment marks is reduced.

The textile printing method may include a treatment liquid composition attaching step of attaching the above-described treatment liquid composition for dye textile printing to a fabric.

According to the textile printing method, the printed matter exhibits favorable color development, and the occurrence of the pretreatment marks is also reduced.

The above-described textile printing method may further include a drying step of drying the treatment liquid composition for dye textile printing, which is attached to the fabric after the treatment liquid composition attaching step.

According to the textile printing method, the printed matter exhibits favorable color development, and the occurrence of the pretreatment marks is also reduced.

In the above-described textile printing method, a heat press method may be used in the drying step.

According to the textile printing method, the printed matter exhibits favorable color development, and the occurrence of the pretreatment marks is also reduced.

In the above-described textile printing method, the fabric may include a fiber having a hydroxy group.

According to the textile printing method, the printed matter exhibits favorable color development, and the discoloration over time is reduced.

In the above-described textile printing method, the fabric may be white cotton and a form of the fabric may be a T-shirt.

According to the textile printing method, the printed matter exhibits favorable color development, and the discoloration over time is also reduced.

What is claimed is:

1. A treatment liquid composition for dye textile printing, comprising:
a resin;
a crosslinking agent;
an additive; and
water, wherein
the additive includes a compound having a polyoxyalkylene structure, and
the compound having a polyoxyalkylene structure is one or more selected from a polyoxyalkylene-glyceryl ether, a polyoxyalkylene-polyglyceryl ether, and a polyoxyalkylene block polymer.

2. The treatment liquid composition for dye textile printing according to claim 1, wherein the compound having a polyoxyalkylene structure has 2 or more and 4 or less carbon atoms in an oxyalkylene group.

3. The treatment liquid composition for dye textile printing according to claim 1, wherein the additive includes the compound having a polyoxyalkylene structure, which has oxyalkylene groups having different numbers of carbon atoms in a molecule.

4. The treatment liquid composition for dye textile printing according to claim 1, wherein the additive includes a compound having three or more hydroxy groups.

5. The treatment liquid composition for dye textile printing according to claim 1, wherein a number-average molecular weight of the compound having a polyoxyalkylene structure is 250 or more and 1,000 or less.

6. The treatment liquid composition for dye textile printing according to claim 1, wherein the resin is a polyester resin.

7. The treatment liquid composition for dye textile printing according to claim 1, wherein a glass transition temperature of the resin is 25° C. or higher.

8. The treatment liquid composition for dye textile printing according to claim 1, wherein a content of the resin is 2% by mass or more and 20% by mass or less in terms of solid content with respect to a total amount of the treatment liquid composition for dye textile printing.

9. The treatment liquid composition for dye textile printing according to claim 1, wherein the crosslinking agent is an isocyanate compound.

10. The treatment liquid composition for dye textile printing according to claim 9, wherein the isocyanate compound has an isocyanurate skeleton in a structure.

11. The treatment liquid composition for dye textile printing according to claim 1, wherein a content of the crosslinking agent is 1% by mass or more and 3% by mass or less in terms of solid content with respect to a total amount of the treatment liquid composition for dye textile printing.

12. The treatment liquid composition for dye textile printing according to claim 1, further comprising:
an organic solvent.

13. A composition set comprising:
the treatment liquid composition for dye textile printing according to claim 1; and
an ink jet ink composition, wherein
the ink jet ink composition contains a disperse dye and water.

14. A textile printing method comprising:
attaching the treatment liquid composition for dye textile printing according to claim 1 to a fabric.

15. The textile printing method according to claim 14, further comprising:
drying the treatment liquid composition for dye textile printing, which is attached to the fabric after the attachment of the treatment liquid composition.

16. The textile printing method according to claim 15, wherein a heat press method is used in the drying.

17. The textile printing method according to claim 14, wherein the fabric includes a fiber having a hydroxy group.

18. The textile printing method according to claim 17, wherein the fabric is white cotton and a form of the fabric is a T-shirt.
